(19) United States
(12) Patent Application Publication
(10) Pub. No.: US 2026/0165896 A1
(43) Pub. Date: Jun. 18, 2026

(54) Lifting Hoist with Telescopic Cross Beam

(71) Applicant: Gregg Cohen, Mesquite, TX (US)

(72) Inventor: Gregg Cohen, Mesquite, TX (US)

(21) Appl. No.: 18/981,578

(22) Filed: Dec. 15, 2024

(51) Int. Cl. A61G 7/10

(52) U.S. Cl. CPC A61G 7/1017; A61G 7/1046; A61G 7/1059

(57) ABSTRACT

A lifting hoist with telescopic cross beam (herein referred to as the ‘lift’) for those with mobility issues is disclosed. The lift is comprised of the following elements: a frame having four upright supports and a telescoping gantry; at least two linear actuators for adjusting both the width and height of the lift; a pivoting spreader bar affixed to the gantry for holding a sling seat; a handheld controller for adjusting said actuators; a battery pack to power the actuators, two sets of articulating driver handles and a base with locking caster wheels. An object of the lift is to allow a person with mobility challenges to be transferred into tight spaces such as hospital beds, airplane seats and train seats safely and easily. Other details regarding this lift are presented further in this disclosure.

### FIELD OF THE INVENTION

The present invention generally relates to transfer lifts. More specifically, it relates to a transfer lift with inline gantry and adjustable horizontal and vertical axes.

### BACKGROUND

Using transfer lifts to assist individuals with mobility limitations involves several complex challenges, impacting both the person being transferred and the caregiver(s) responsible for operating the lift. One of the foremost concerns is ensuring safety throughout the transfer process. Since improper positioning, insufficient or misused straps, or mishandling can lead to falls or other injuries, transfer lifts require careful and precise use. For individuals with limited mobility, even a minor mishap can have severe consequences, so the need for accuracy and attentiveness in positioning cannot be overstated. Furthermore, ensuring that the individual feels secure in the lift is essential, as any instability may cause discomfort or anxiety, which could make the transfer process even more challenging. The physical demands placed on caregivers are also significant. While transfer lifts are designed to assist with the weight and movement of individuals, caregivers often need to position and stabilize the individual in the lift. This can require substantial physical effort, leading to potential strain, especially when performed frequently or over extended shifts. Even with proper technique, repetitive actions such as attaching straps, adjusting positioning, or moving the lift across varying surfaces can lead to musculoskeletal stress or injury in caregivers, particularly if the equipment is not well-suited to the specific needs or settings in which it's used.

Compatibility between the transfer lift and the individual's unique physical condition is another critical factor. Mobility needs vary widely; some individuals may require more support than others, and if the lift lacks the necessary adjustments or adaptability, the user may experience discomfort, improper positioning, or inefficient transfers. This can be exacerbated by the surrounding environment. For example, narrow hallways, tight rooms, or uneven floors can make it difficult to maneuver the lift or position it effectively, particularly in homes or small care facilities where space constraints are common. These limitations can complicate the transfer, making it harder to ensure smooth and comfortable movement from one place to another. For the individual being transferred, the experience can sometimes feel unsettling or even distressing. The sensation of being lifted, especially if not fully secure or comfortable, may evoke anxiety or a sense of vulnerability. Some individuals experience a loss of autonomy in this process, which can impact their psychological well-being over time, especially if transfers are frequent. Additionally, prolonged positioning in the lift can cause physical discomfort, particularly if the lift is not fitted correctly to the individual's size or body shape.

The common ‘cherry picker’ type of transfer lift, also known as a floor-based or mobile hoist, presents specific dangers that can make the transfer process risky for both the individual being lifted and the caregiver operating the device. These types of lifts are popular due to their portability and versatility, but their design can introduce safety hazards, particularly in environments where space, training, or equipment maintenance is limited. One primary danger of cherry picker lifts is their instability on uneven surfaces or in confined spaces. The lift's base often consists of a wheeled frame designed to roll smoothly, but these wheels can be challenging to control on uneven flooring or carpeting. In home environments or older care facilities with narrow doorways, cluttered spaces, or tight corridors, maneuvering the lift can become cumbersome, raising the risk of tipping or jostling the person being transferred. If the lift were to tip or sway unexpectedly, even a slight movement could lead to a fall, resulting in serious injury for the individual.

The cherry picker design also requires precise balancing of weight, which can be difficult to achieve consistently. The individual being transferred is often positioned some distance away from the lift's central column, creating a leverage effect that can strain the base and reduce stability. If the weight is unevenly distributed or if the individual's positioning shifts during the transfer, the lift may become unsteady. Additionally, improper use or lack of training in positioning the individual's body within the lift's sling can cause weight to shift unpredictably, increasing the potential for falls or injury. For the caregiver, the physical effort needed to operate a cherry picker lift, especially if it involves pushing, pulling, or maneuvering around obstacles, can lead to strain or injury. Although these lifts are designed to bear the weight of the individual, controlling the lift's movement across a room or through a doorway often requires substantial physical exertion. In the absence of correct ergonomic techniques, caregivers may be at risk of musculoskeletal injuries. For caregivers who perform multiple transfers daily, the cumulative strain of manually positioning and stabilizing the lift over time can be substantial. In terms of psychological impact, cherry picker lifts can also create a sense of vulnerability for the individual being transferred. The often suspended, open-air nature of the transfer can be uncomfortable and anxiety-inducing, particularly for individuals who have experienced a previous fall or who have conditions affecting balance or perception. Additionally, because the individual is positioned at a height during the transfer, any instability or sudden movements can exacerbate these feelings, potentially leading to a heightened sense of fear and reluctance to use the lift over time. Many in the health care industry have developed transfer lifts for patients. United States Patent No. U.S. Pat. No. 6,430,761B1 disclosed a rolling telescopic lift—however it only adjusts in the vertical axis. United States Patent Nos. US20050210579A1, U.S. Pat. Nos. 7,690,056B2, 7,428,759B2, US20030208844A1, US20050097670A, 1U.S. Pat. No. 7,611,203B1 and US20060026755A1 all disclosed cherry picker style lifts and they do not include an inline gantry with dual leg supports. What is needed is a stable gantry style lift with multiple, adjustable supports.

### SUMMARY OF THE INVENTION

The device herein disclosed and described provides a solution to the shortcomings in the prior art through the disclosure of a transfer lift with inline gantry. An object of the lift is to provide enhance stability and safety. A majority of conventional lifts rely on a cherry picker style design with a single, articulating arm. In order to prevent tipping when the arm swings, these lifts usually rely on a wide distance between the wheels making them difficult to traverse tight spaces. The current disclosure presents a lift whereby the patient is centered on the gantry and is surrounded by four upright supports allowing for greater stability. The wheels are closer together allowing it to navigate small spaces such as narrow aisles.

Another object of the invention is to provide a means to adjust both the height and the width of the lift. The upright supports on each side of the lift have sliding rails connected to linear actuators. The gantry is telescopic and is also connected to a linear actuator. A handheld remote controls both of the actuators.

Another object of the invention is to provide a means to secure a patient inside the lift safely. The lift includes a double-hook, pivoting spreader bar that connects to conventional seat slings.

Another object of the invention is to provide a means to secure a patient's feet inside the lift. The lift includes two small, adjustable stirrups that allows a user to insert their feet

Another object of the invention is to provide an onboard power supply that can be easily carried and stowed on the lift when in use. The apparatus includes a carry bag for the battery that can be carried and secured to the lift uprights.

Another object of the invention is to provide a means for pushing and pulling the lift with a set of articulating drive handles on each side. The handles also allow an assistant to slightly raise one side of the lift when rolling over rough surfaces. When not in use, these handles are positioned down alongside the supports for a streamlined profile.

Another object of the invention is to provide a braking system for the lift. The caster wheels at the bottom have foot-operated locks to prevent it from moving during loading and unloading a patient.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features, and advantages of the present invention, as well as the advantages thereof over existing prior art, which will become apparent from the description to follow, are accomplished by the improvements described in this specification and hereinafter described in the following detailed description which fully discloses the invention.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a front perspective view of the lift.

FIG. 2 shows a front perspective view of the lift with a patient.

FIG. 3 shows a side view of the lift vertically extended and compressed.

FIG. 4 shows a side view of the lift horizontally compressed and extended.

FIG. 5 shows a representative view of the lift's method.

Other aspects of the present invention shall be more readily understood when considered in conjunction with the accompanying drawings, and the following detailed description, neither of which should be considered limiting.

### DETAILED DESCRIPTION

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation. Conventional components of the invention are elements that are well-known in the prior art and will not be discussed in detail for this disclosure.

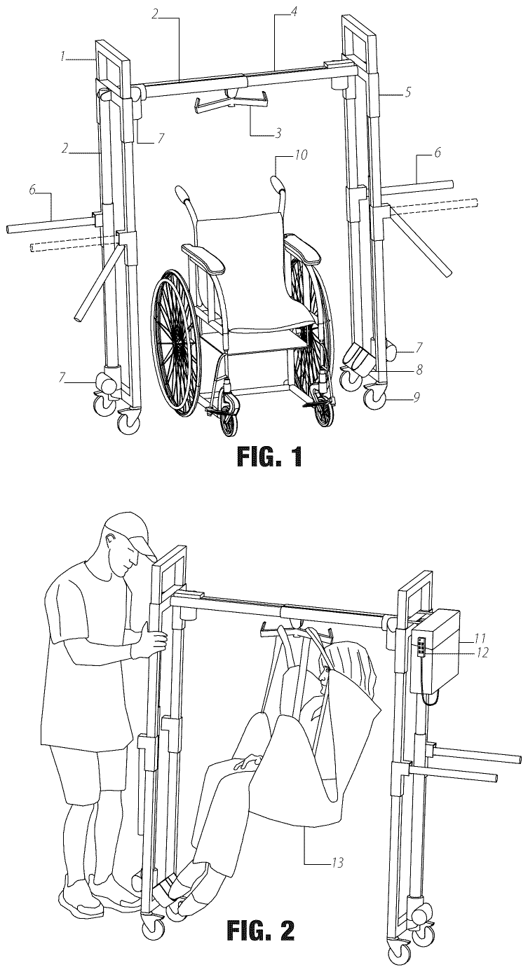

FIG. 1 shows a front, perspective view of a preferred embodiment of the lift having a frame that is square-shape and accommodating a wheelchair 10 therein. Each distal end of the lift having at least two, upright supports 1 connected by a telescoping gantry 4 by means of slidable cross members 5 that allow said telescoping gantry 4 to be raised and lowered. Conversely, said telescoping gantry 4 allowing the lift width to be wider or narrower depending upon patient size. Each of the upright supports 1 being rectangular in shape and having at least four locking caster wheels 9 and at least two adjustable stirrups 8 on a distal end. At least four articulating driver handles 6 are pivotably-connected proximally on the upright supports 1 allowing users to push, pull and even raise the lift during transfers. A conventional, pivoting spreader bar 3 for holding a sling seat 13 (as shown in FIG. 2) is pivotably and proximally affixed to telescoping gantry 4 by means of a swivel connection. Telescoping gantry 4 having a linear actuator 2 with electric motor 7 allowing both sections of said telescoping gantry 4 to expand and contract. Upright supports 1 also having linear actuators 2 with electric motors 7 allowing slidable cross members 5 to raise and lower telescopic gantry 4 in unison. All elements of the lift are made of a rigid material such as, but not limited to steel and aluminum metals and the like.

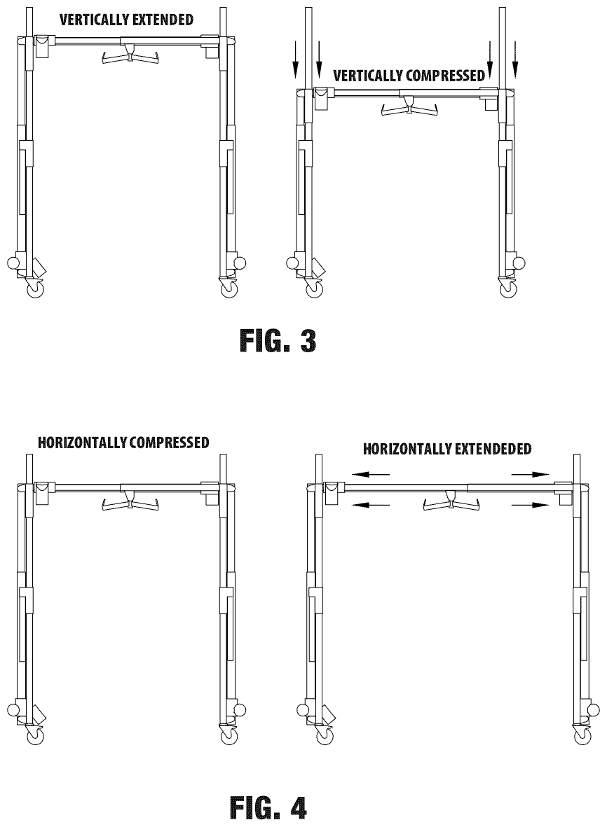

FIG. 2 shows a front perspective view of the lift with a patient sitting in a conventional seat sling 13 connected to the lift by means of pivoting spreader bar 3. Said linear actuators 2 being powered by a conventional lithium battery inside detachable battery bag 11. The movement of said linear actuators 2 being controlled by a hard-wired, handheld remote 12. Other embodiments of handheld remote 12 may be wireless and include a mobile software application. FIG. 3 shows a side view of the lift vertically extended and compressed. FIG. 4 shows a side view of the lift horizontally compressed and extended.

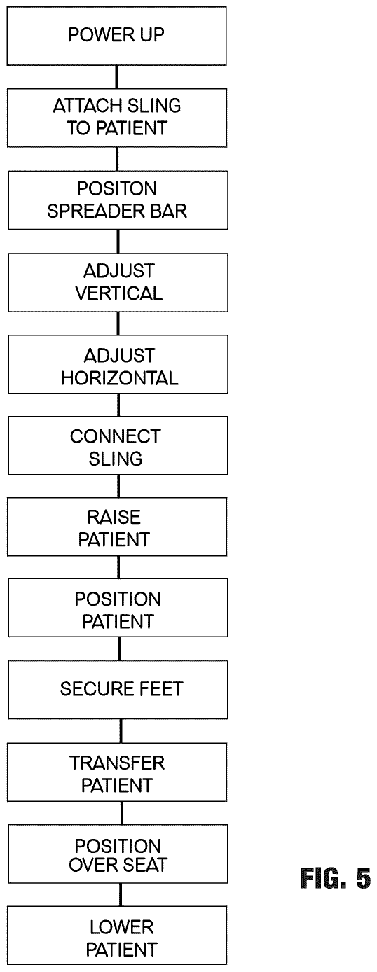

FIG. 5 shows a representative view of the lift's method that includes but is not limited to the following steps: powering on linear actuators 2 by means of handheld remote 12; attaching conventional sling 13 to a patient; positioning spreader bar 3 to be parallel with telescoping gantry 4; performing a vertical height adjustment of the of telescoping gantry 4 using handheld remote 12 and moving slidable cross members 5; performing a horizontal width adjustment of the of telescoping gantry 4 using handheld remote 12; securing straps on said conventional sling 13 to arms on spreader bar 3; raising patent by means of adjusting the vertical height of the of telescoping gantry 4 using handheld remote 12 and moving slidable cross members 5; positioning a patient's body in the lift to be parallel to the telescopic gantry 4 by carefully rotating spreader bar 3; securing patient's feet to adjustable stirrups 8, transferring patient by pushing and pulling the lift using driver handles 6; positioning the lift over a seat; and lowering patient into said seat by lowering the vertical height of the of telescoping gantry 4 using handheld remote 12 and moving slidable cross members 5.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

What is claimed is:

1. A transfer lift system for individuals with mobility challenges, comprising:
a) a frame with four upright supports, each support having a locking caster wheel;
b) a telescoping gantry connected to the upright supports by slidable cross members;
c) at least two linear actuators configured to adjust the height and width of the telescoping gantry;
d) a pivoting spreader bar affixed to the gantry and adapted to hold a sling seat;
e) a handheld controller operably connected to the linear actuators for adjusting the height and width of the gantry;
f) a battery configured to power the linear actuators; and
g) a set of articulating driver handles pivotably attached to the upright supports, enabling manual movement and positioning of the lift and allowing users to push, pull and even raise the lift during transfers.

2. The system of claim 1, wherein the articulating driver handles are positioned to allow an assistant to raise one side of the lift.

3. The system of claim 1, further comprising adjustable stirrups attached to a distal end of the upright supports to secure a patient's feet during transfer.

4. The system of claim 1, wherein the handheld controller is configured as a hard-wired remote.

5. The system of claim 1, further comprising a detachable battery bag that can be securely attached to the upright supports for convenient stowage and access.

6. A method for transferring an individual with limited mobility using a transfer lift system, comprising the steps of:
a) providing the a transfer lift system
b) powering on linear actuators by means of a handheld controller;
c) attaching a conventional sling to a patient and connecting it to a pivoting spreader bar on the transfer lift;
d) adjusting the vertical height of a telescoping gantry using the handheld controller;
e) adjusting the horizontal width of the telescoping gantry using the handheld controller;
f) securing the patient's feet within adjustable stirrups located at the base of the lift;
g) moving the lift by pushing or pulling articulating driver handles attached to the upright supports;
h) positioning the lift over a target seat for transfer; and
I) lowering the patient into the target seat by adjusting the vertical height of the telescoping gantry.

7. The method of claim 6, further comprising the step of securing the battery pack in a detachable battery bag that attaches to the upright supports.

8. The method of claim 6, further comprising the step of locking the caster wheels before lifting or lowering the patient to stabilize the lift.

9. The method of claim 6, wherein the pivoting spreader bar is adjusted to align the patient's body parallel to the telescoping gantry for optimized transfer positioning
